(19) United States
(12) Patent Application Publication
(10) Pub. No.: US 2019/0043079 A1
(43) Pub. Date: Feb. 7, 2019

(54) LEVERAGING PERFORMANCE DATA TO AUTOMATICALLY SELECT CONTENT ITEMS

(71) Applicant: Microsoft Technology Licensing, LLC, Redmond, WA (US)

(72) Inventors: Xiang Yu, Sunnyvale, CA (US); Yingfeng Oh, Cupertino, CA (US)

(21) Appl. No.: 15/669,848

(22) Filed: Aug. 4, 2017

(51) Int. Cl. G06Q 30/02

(52) U.S. Cl. CPC G06Q 30/0244; G06Q 30/0277; H04L 67/02; G06Q 30/0254; G06Q 30/0261

(57) ABSTRACT

Techniques for leveraging performance data to dynamically selecting content item-format pairs are provided. In response to receiving a request, a content campaign is selected and feature values associated with the request are identified. Based on the feature values, performance values are identified, where each performance value is associated with a different content item-format pair of multiple content item-format pairs. Based on the performance values, a particular content item-format pair is selected. The selected pair may not be associated with the highest performance value. The particular content item of the selected pair is transmitted over a computer network and presented on a computing device according to the format of the selected pair.

### TECHNICAL FIELD

The present invention relates generally to transmission of content items over computer networks and, more particularly, to generating performance data associated with different content items and using the performance data to intelligently select a content item in response to a content item selection event. SUGGESTED CLASSIFICATION: 709/203; SUGGESTED ART UNIT: 2447

### BACKGROUND

The Internet allows end-users operating computing devices to request content from many different publishers. Some publishers desire to send additional content items to users who visit their respective websites or who otherwise interact with the publishers. To do so, publishers may rely on a content delivery service that delivers the additional content items over one or more computer networks to computing devices of such users. Some content delivery services have a large database of content items from which to select. In many cases, many slightly different content items provided by a particular content provider may be eligible for selection and delivery over a computer network. However, it is difficult for a content provider to intelligently select (ahead of time) which of many content items should be delivered, much less doing so in real-time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram that depicts a relationship between a dynamic content delivery campaign, different content item types, and different format groups, in an embodiment;

FIG. 3 is a block diagram that depicts these various inputs into an automatic content item and format selection (ACFS) system, in an embodiment;

FIG. 4 is a block diagram that depicts a system for offline modeling and online content item-format pair selection, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for intelligently selecting content item-format pairs and generating dynamic content items are provided. When a content delivery campaign is selected in response to a content request received over a computer network, one of multiple possible content items associated with that content delivery campaign may be presented in response to the content request. Instead of requiring a user to manually select a particular content item and a particular format for any particular content request, past performance data is used to dynamically select a content item-format pair, from which a finalized content item is generated and transmitted over the computer network.

### System Overview

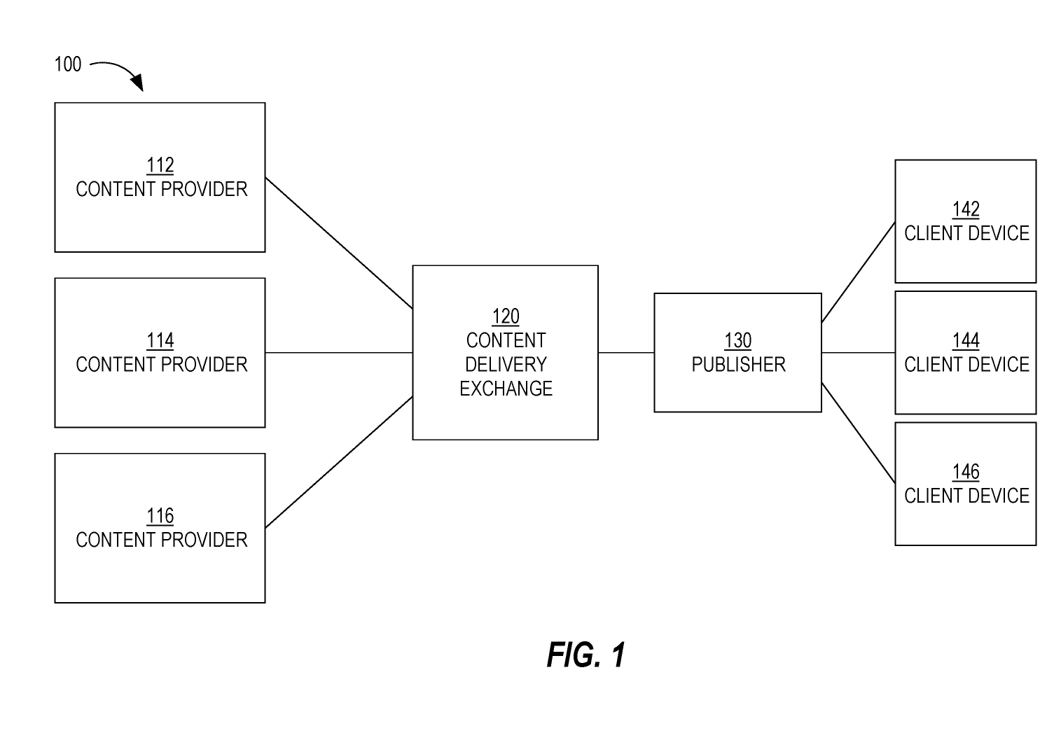

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Although depicted in a single element, content delivery exchange may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery campaign 120 may select a strict subset of the identified content delivery campaigns from which content items will be identified and presented to the user of the computing device.

Instead of one set of targeting criteria, a single content delivery campaign may be associated with multiple sets of targeting criteria over time. For example, one set of targeting criteria may be used during one period of time of the content delivery campaign and another set of targeting criteria may be used during another period of time of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a resource budget that indicates how much the corresponding content provider is willing to be charged by content delivery exchange 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items are considered and a subset selected for presentation on a computing device in response to a request. Thus, each content request that content delivery exchange 120 receives triggers a content item selection event.

For example, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 120 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event, information such as the minimum winning bid or the highest bid of the content item that was not selected during the content item selection event.

### Tracking User Interactions

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device.

### Dynamic Content Items

A “dynamic content item” is a content item that is generated dynamically from user data and/or contextual data. User data (also referred to herein as entity data) may include data from a user's online profile, data describing online activity that the user (or “viewer” or “viewing entity”) has initiated or performed (e.g., searches, web sites visited, and online articles commented, liked, or shared), and/or the user's social data (e.g., the connections of the user, companies the user is following). Contextual data may include data about the page (or content) and the content/ad slot that a viewer requested and through which the content item will be presented (e.g., displayed or played).

For example, when a LinkedIn member views another Linkedin member's profile, who works for Company X, the viewer can be served (or presented with) a dynamic content item, which may include the text “Picture Yourself at Company X” or text “Work with us at Company X”, along with a logo of Company X, a profile picture of the viewer, a name of the viewer, a list of one or more job titles of job openings (matching the viewer) at Company X, and a location of each job opening.

A content delivery campaign from which one or more dynamic content items originate is referred to herein as a “dynamic campaign.” A dynamic campaign can be created with one or more types of content items and, for each type of content item, one or more formats. Different types of content items support (or are associated with) a different format group of a set of format groups. Such, for content item type A, there is a group of two formats; while for content item type B, there is a group of four formats. Also, the same dynamic campaign may be associated with multiple content items of the same type.

Examples of content item types that a single dynamic campaign may have include “WorkWithUs,” “PictureYourself,” “FollowCompany,” and “Spotlight.” Different content item types may be restricted to being displayed on certain web pages. For example, a “PictureYourself” content item, a “WorkWithUs” content item, and a “FollowCompany” content item can be displayed on an organization's (e.g., a company's) profile page while a “Spotlight” content item cannot. As another example, only “PictureYourself” and “FollowCompany” content items can be displayed on member profile pages while and “Spotlight” content items can only be displayed on search pages.

A format indicates a “look and feel” of a rendered content item. Different formats may specify that certain types of data items should be presented in a certain way. For example, one format may specify that a job title appears to the right of a person's profile picture while another format may specify that a job title appears immediately above the person's profile picture. Different formats may also specify which types of data items will be displayed at all. For example, one format may specify that a certain background image is to be included, whereas another format may specify that a different background image (or no background image) should be included.

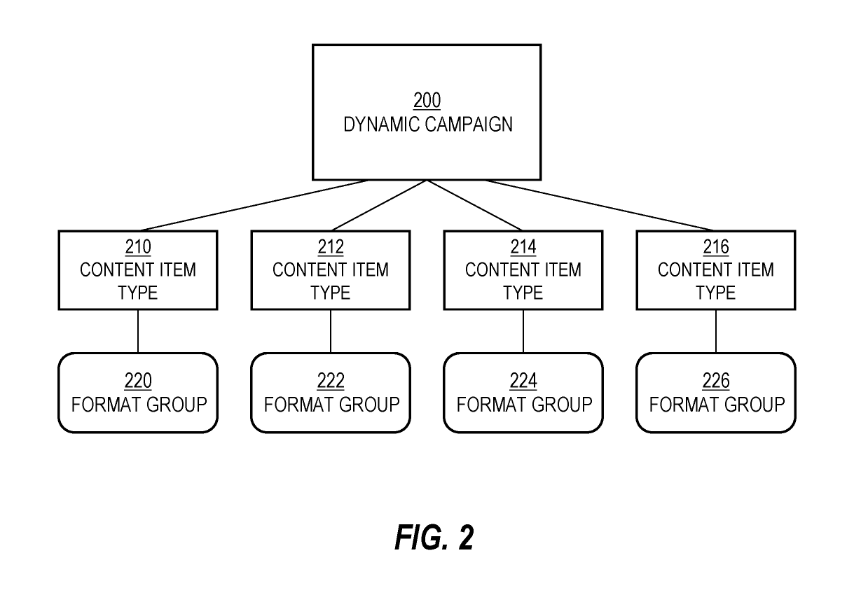

FIG. 2 is a block diagram that depicts a relationship between a dynamic content delivery campaign 200, different content item types 210-216, and different format groups 220-226, in an embodiment. Dynamic campaign 200 is associated with four content item types 210-216. Content item types 210-216 may reflect all possible types that can be associated with a dynamic campaign or may reflect just the types that a particular content provider selected for dynamic campaign 200. Each of content item types 210-216 is associated with a different format group of format groups 220-226. Thus, content item type 210 is associated with format group 220, content item type 212 is associated with format group 222, and so forth. Format group 220 includes three formats, format group 222 includes one format, format group 224 includes four formats, and format group 226 includes two formats. Thus, a particular format corresponding to one content item type is not necessarily applicable to other content item types.

### Approaches for Selecting a Content Item

If a content delivery campaign is a dynamic campaign, then a particular content item-format pair associated with the dynamic campaign is selected from among multiple possible content item-format pairs. This is referred to herein as a “pair selection event.” Even though the same content item-format pair is selected in two different pair selection events and that content item-format pair is presented to two different end users (or even the same end user), the two instances of the content item-format pair is likely not to be exactly the same because the viewers may be different (in case of different viewers), attributes of a single viewer (in the case of the same viewer viewing the two instances of the content item-format pair) may have changed between pair selection events (e.g., employment status changed), or the context has changed. For example, a viewer may view a profile page of a first user at time A and a profile page of a second user (that is different than the first user) at time B. If the first user and the second user are employed at different companies or have any other differences in their respective profiles, then content items that are presented to the viewer on the respective profile pages, even though the content items are generated based on the same content item-format pair, may have different content, such as a different company name.

In one approach for conducting a pair selection event, content items of different types are rotated between content requests. For example, in response to a first content request, a content item of a first type is selected for responding to the first content request. In response to a second content request, a content item of a second type (that is different than the first type) is selected for responding to the second content request.

A similar approach to conducting a pair selection event involves a waterfall approach where, in response to a single request, once a dynamic content delivery campaign has been selected, a content item of a first type is considered for electronic delivery before a content item of another type is considered for electronic delivery. If a first content item does not satisfy one or more requirements of a content request, then a second content item of a different type may be processed to determine if the second content item satisfies the requirements of the content request.

However, both approaches suffer from not being optimized using performance data. The large number of possibilities resulting from the combination of different content item types and different formats for a given content delivery campaign lends itself to a data driven optimization scheme.

### Selecting a Content Item-Format Pair

During a content item selection event, information about the viewer (i.e., the user that initiated the corresponding content request) and/or information about the requested content (e.g., content of a requested web page) may be considered in selecting a particular content delivery campaign (e.g., from among multiple content delivery campaigns). A bid amount and/or a predicted CTR associated with each candidate content delivery campaign may have been used to select the particular campaign. If the particular campaign is a dynamic campaign, then a particular content item-format pair associated with the dynamic campaign is selected from among multiple possible content item-format pairs. For example, if there are four different content items (e.g., each of a different type) and each type is associated with two formats, then there are eight different content item-format pairs from which to choose in the pair selection event. With a relatively large number of pairs, the type of performance data used to select the pair may be important.

Examples of types of performance data for each content item-format pair include user selection rate (or CTR), revenue, campaign reach (e.g., users from different sub-segments interacting with the campaign), conversion rate (e.g., job application rate, number of company follows, number of filled out web forms, number of purchases), and engagement (e.g., likes, shares, comments, and posts). While the description herein is in the context of user selection rate, embodiments are not limited to this particular type of performance data.

Over time, as a dynamic campaign is active and has been finally selected for multiple content item selection events, each content item-format pair associated with the dynamic campaign becomes associated with different performance data. For example, one content item-format pair is associated with a user selection rate of 1% while another content item-format pair is associated with a user selection rate of 4%.

In an embodiment, during a pair selection event, the performance data of each pair relative to the performance data of all pairs is used to select a particular pair. For example, pair A is associated with a user selection rate of 3%, pair B is associated with a user selection rate of 5%, and pair C is associated with a user selection rate of 2%. The probability of selecting pair A is then 3%/10% (or 30%), the probability of selecting pair B is 5%/10% (or 50%), and the probability of selecting pair C is 2%/10% (or 20%). If the performance data does not change, then this means that pair B will be selected around 50% of the time that the corresponding dynamic campaign is finally selected for a content item selection event.

Once selection probabilities are determined for a set of content item-format pairs, a pair selection event may involve generating a random (or pseudo random) number and performing a modulo operation on that number, such as random number mod 100, which returns a value between 0 and 99. The selection probabilities of a set of content-format pairs may be mapped to this range of values. Given the above example of three pairs, values 0-29 might map to pair A, values 30-49 might map to pair B, and values 50-99 might map to pair C. If the random number generation is truly “random,” then, as the number of selection opportunities increases, the actual selection rate of, for example, pair C approaches 50%.

In an embodiment, a weight is applied during a pair selection event, such that the selection probability of a content item-format pair is not exactly proportional to the pair's performance data relative to the whole (as in the three-pair example above). The weight may be given to pairs that are relatively low performing. For example, in the above three-pair example, if the probability of any pair is below 33%, then the probability is increased 5%, but capped at 33%, which means that the probability of selecting pair C would be 25%, the probability of selecting pair A would be 33%, and the probability of selecting pair B would be 42% (100%−25%−33%).

In a related embodiment where a weight is applied, the weight is adjusted over time. For example, the weight may change based on clock time or based on the amount of performance data that is available. As a specific example, initially, each pair of a dynamic campaign is selected with equal probability (e.g., if there are 10 pairs, then each pair has a selection probability of 10%, regardless of performance) or even selected in a round robin fashion. After a week, the selection probability of each pair is directly proportional to its performance relative to the total performance of the all pairs of the dynamic campaign. After another week, the selection probability of the bottom three pairs are zeroed and the selection probability of the top three pairs are increased based on the previous non-zero selection probabilities of the bottom three pairs.

In an embodiment, some content item-format pairs of a dynamic campaign cannot be selected due to one or more restrictions. For example, a particular type of content item cannot be displayed on a particular web page associated with the corresponding content request. As a specific example, if the WorkWithUs format requires three jobs while the dynamic content only generated one matching job for a viewer, then the WorkWithUs format cannot be used in the pair selection event. In that case, one or more content item-format pairs are off limits. If, during a pair selection event, a particular pair is selected but cannot be displayed due to a restriction, then one or more additional pair selection events are conducted until a pair is selected that can be displayed.

### Attribute-Based Selection of a Content Item-Format Pair

The above examples regarding pair selection events are agnostic to the attributes of the content requests that initiated the pair selection events. In an embodiment, attributes of a content request are used to select a particular content item-format pair during a pair selection event. Example types of attributes include page context attributes, viewer attributes, and social attributes.

Examples of page context attributes include a publisher identifier (which may identify an affiliate entity (e.g., SlideShare.net or Lynda.com relative to LinkedIn) or a third-party publisher that is not a corporate affiliate of the entity that operates content delivery exchange 120), a page identifier (e.g., that identifies a specify type of web page, such as a member profile page, a company profile page, a search page, etc.) a page zone (where each page is divided into multiple zones in which a rendered content item will be displayed in the page zone), a tile (which is one of multiple possible locations within a particular page zone), a slot size (which indicates an upper limit on the size of a rendered content item), contextual geography (which indicates a geographic location associated with content of the page on which the content item will be displayed), and a contextual organization (which indicates an organization that is associated with the page on which the content item will be displayed).

Examples of viewer attributes include whether the viewer is currently logged in, whether the viewer has a profile picture, a job title of the viewer, a geographic location associated with the viewer (e.g., specified in the viewer's member profile), a name of an organization with which the viewer is affiliated (e.g., employed), a member follow status, and a member connection status.

“Member follow status” is an indication of whether the viewer is already following the contextual organization/company (i.e., whose information is being displayed on the page, if applicable) (e.g., the user previously selected a “Follow” button associated with the organization, resulting in the viewer receiving updates about the organization from time to time). Member follow status may be helpful when selecting a content item if one of the candidate content items is about following the contextual organization. If the viewer is already following the contextual organization, then that content item should not be presented to the viewer.

“Member connection status” is an indication that the viewer has a connection/friend who can be referred to work at the contextual organization/company. Member connection status may be helpful when selecting a content item if one of the candidate content items is about referring a friend to the contextual organization. If the viewer does not have any connections/friends who have skills required by a job opening of the contextual organization, then that content item should not be presented to the viewer.

Examples of social attributes include whether attributes of a job opening of the contextual organization match (or satisfy) attributes of the viewer and whether attributes of a connection of the viewer match (or satisfy) job referral requirements of the contextual organization (in the case where there is a contextual organization).

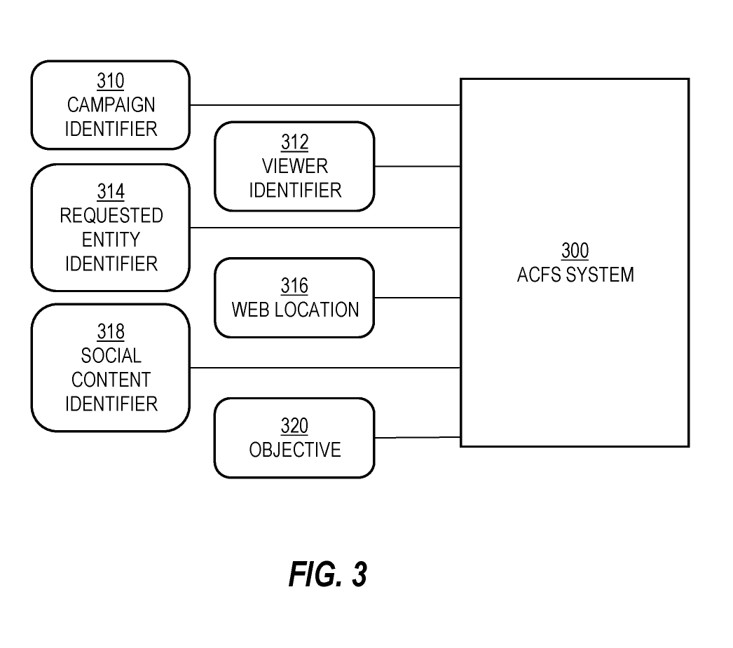

FIG. 3 is a block diagram that depicts these various inputs (or feature values) into an automatic content item and format selection (ACFS) system 300, in an embodiment. ACFS system 300 conducts a pair selection event in response to receiving a set of inputs. ACFS system 300 may be implemented as part of content delivery exchange 120. Inputs to ACFS system 300 include a campaign identifier 310, a viewer identifier 312, a requested entity identifier 314, a web location 316, a social content identifier 118, and an objective 320. Campaign identifier 310 is a unique identifier that is used to identify the possible content items and formats associated with a particular campaign.

Viewer identifier 312 may be a unique identifier that uniquely identifies a particular user or member, which may have an account maintained by an entity (e.g., a social network service) associated with content delivery exchange 120. Such an identifier may be used to look up information about the viewer (e.g., from the viewer's social profile), such as current employer, job title, seniority, geographic location, and online activity. Each of these types of user information may be considered a user/entity feature value. Alternatively, viewer identifier 312 comprises a set of one or more attribute values of the viewer that initiated a content request to content delivery exchange 120. In this case, the viewer may be a logged out user or member or may be an unregistered user, about which little is known, except for an IP address, a MAC address, a cookie that is associated with past online behavior, and device information regarding the computing device that the viewer is operating and that initiated the content request (e.g., operating system, type of device). An IP address may be mapped to a geographic location. For logged out viewers, there are mechanisms to do id-mapping or to identify a logout member via different resources. For example, an IDFA of an iOS device may be converted to a logged in member identifier.

Requested entity identifier 314 may be a unique identifier that uniquely identifies an entity about which the viewer has requested information. For example, a requested entity may be another member of a social network, an organization, or a group of users. For example, the viewer may have requested to view a particular user's profile or a profile of a particular company. With a requested entity identifier 314, information about the identified requested entity may be retrieved (e.g., by AFCS system 300). In the case where the requested entity is a person, relevant information about the requested entity may include the same type of information as the information of the viewer described above (e.g., job title, employer, skills, etc.). In the case where the requested entity is an organization, relevant information about the requested entity may include a name of the organization, a logo of the organization, any job openings, number of employees, geographic location, mailing address, type of organization (e.g., public, private, non-profit), and a website or URL of the organization. Each of these types of contextual information may be considered a contextual entity feature value.

Web location 316 of a particular pair selection event may refer to a single type of location or multiple types of locations, examples of which include a web domain (e.g., linkedin.com, Lynda.com, or Microsoft.com), a page identifier, zone, tile, slot size, identifier of requested contextual entity, and geographic location associated with the requested contextual entity.

Social content identifier 318 indicates the dynamic content matched between the viewer and the context the viewer is viewing. For example, the social content identifier 318 identifies a type of social content, such as a list of matched jobs (available from the context company) for a viewer, or a list of matched connections of a viewer for the context company that needs a referrer. As a specific example, prior to calling ACFS system 300, a component (not depicted) identifies, based on the viewer and the contextual organization/company, (1) five matched jobs with relatively high social scores and (2) two matched connections with relatively medium or low social scores. Based on these scores, ACFS system 300 might rank a WorkWithUs content type (corresponding to the matched jobs) over a Referral content type (corresponding to the matched connections) because the matched jobs are more relevant (as indicated by the respective social scores).

Similar to a viewer identifier, a social content identifier may be a social content feature value itself (e.g., a list of matched jobs with any accompanying scores) or may be used to look up one or more social content feature values associated with the identifier. “Social content” may be dynamic content that is generated or determined based on both the viewer and the contextual entity/content. Examples of social content include matched jobs and matched connections (as described above), and recommendations for events, lessons, literature for a company. For example, a registered user without a Computer Science degree is browsing a software engineer profile page or a company jobs page. In this case, social content that is determined to be displayed to this registered user include online CS courses or CS books instead of recommend jobs. As another example, a user is viewing a company page of Company X and, in response, the system selects content items that provide information regarding upcoming events about, or hosted by, Company X.

Objective 320 may include user selection rate (e.g., CTR), revenue, audience reach, engagement, and so forth. Audience reach of a content item type is a number of unique users or viewers who have viewed a content item of that type. If the objective of a content delivery campaign is audience reach, then it is likely that each possible content item-format pair is selected in a round robin fashion. Engagement of a content item refers to whether or to what extent the content item leads to the viewer remaining within a particular domain or selecting other web pages of the same web site. Example units to measure engagement include (1) average number of internal web pages that viewers of a particular content item-format pair visit after that particular pair is displayed to (or selected by) the viewers and (2) average time viewers spend viewing content from the publisher after a particular pair is displayed to (or selected by) the viewers. Thus, some content items may be associated with higher engagement than others. In a system where dynamic campaigns are associated with a CPM charging model, objective 320 may be user selection rate.

Objective 320 may also be a combined objective that is based on one or more of the above example objectives. For example, a combined objective may be defined as alpha*CTR+beta*audience_reach+gamma*traffic_diversion.

Thus, given a traditional content delivery campaign, the content of a rendered content item is determined solely by content provided by the content provider that initiated the campaign. In the case of dynamic campaign, the content of a rendered content item is determined not only by the content provider, but also by information from the viewer, the requested entity, the web location, and/or a format group associated with the content item type of the content item.

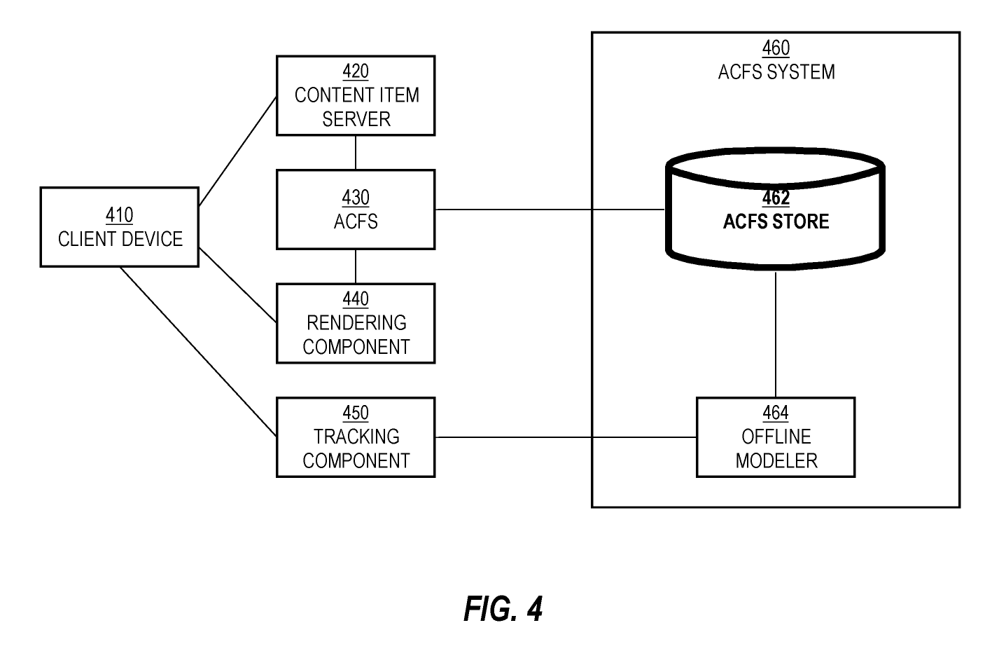

FIG. 4 is a block diagram that depicts a system 400 for offline modeling and online content item-format pair selection, in an embodiment. System 400 includes a client device 410, a content item server 420, ACFS 430, rendering component 440, tracking component 450, and an offline modeling component 460 that comprises an ACFS store 462 and offline modeler 464. Each of content item server 420, ACFS 430, rendering component 440, tracking component 450, and offline modeler 464 is implemented in hardware, software, or any combination of hardware and software.

Client device 410 transmits, to content item server 420, a request for content. The request may be generated and transmitted in response to client device 410 executing code within previously requested web content. Although only one client device is depicted, many client devices may be communicatively coupled to (and, thus, interact with) content item server 420.

Content item server 420 selects one or more content delivery campaigns during a content item selection event. For each content delivery campaign, ACFS 430 sends, to ACFS store 462, multi-dimensional data, include campaign data (e.g., a campaign ID), contextual data (e.g., publisher ID, page identifier, contextual company), and/or user/social data (e.g., job title, geography, employer, has profile picture, connection data, follow data). For each content delivery campaign and based on user selection rate data (e.g., CTR data) retrieved from ACFS store 462, ACFS 430 selects a particular content item-format pair for each content delivery campaign. This “pair selection event” is described in more detail below.

Rendering component 440 receives, from ACFS 430, data about the selected content item and the selected format, packages the content item according to the selected format in the form of HTML and Javascript, including any style data (e.g., CSS style data), and returns the packaged data to client device 410, which renders (e.g., using a web browser) the packaged data into text, images, colors, etc.

Tracking component 450 may receive from client device 410, event data that includes one or more event data items and indicates whether the content item was displayed on client device 410 (impression data) and, optionally, whether the user selected (e.g., clicked, or otherwise interacted with) the content item (click or conversion data). Tracking component 450 receives event data from other client devices, not depicted in FIG. 4. Each event data item may include relatively granular information beyond simply whether an impression or click or conversion occurred, such as a page identifier, a page zone, a slot size, a format of the content item, a target identifier (i.e., that uniquely identifies a user or registered member), and contextual information (e.g., a contextual entity identifier). Each set of event data received from a client device is stored or maintained in an event record. Each event record include multiple event data items.

Tracking component 450 may retrieve additional data before sending an event record to offline modeler 464. For example, if a set of event data item includes a target identifier, then offline modeler 464 (or another component) retrieves information about the target based on the target identifier. As another example, if an event data item includes a contextual entity identifier, then offline modeler 464 (or another component) retrieves information about the contextual entity (e.g., a company or another user or registered member) based on the contextual entity identifier. The additional data is included in the event record associated with the retrieved data.

Offline modeler 464 analyzes event records received by tracking component and generates a model based on the analysis. The model may be one of different types. Because there are many different possible combination of dimension values (e.g., one for each of multiple user attributes, one for each of multiple contextual attributes, one for content type, one for format of content item, etc.), one model generation technique involves identifying event records that share common dimension values (e.g., format, content type, target job title, target geography) and calculating a user selection rate (e.g., CTR) based on the identified event records. (As noted previously, other embodiments may involve calculating different objective metrics of a different type than user selection rate, such as audience reach or conversion.) Thus, the same event record may be used to calculate a user selection rate for different combinations of dimension values. In fact, the same event record may be used to calculate for a first combination of dimension values and a second combination of dimension values that is a sub-combination of the first. For example, one event record includes the following dimension values: D1A, D2B, D3C, and D4D. The first combination may be D1A, D2B, D3C and the second (sub-) combination may be just D1A and D2B.

In order to calculate an aggregate (e.g., mean or median) user selection rate for a particular set of dimension values, offline modeler 464 may require a minimum number of events records (or sets of dimension values), such as forty.

Offline modeler 464, based on its analysis of event records, may determine that some dimension values have very little information. For example, relatively few event records may exist for a particular employer (i.e., reflected in user profile data). Thus, any event records that indicate the particular employer may be used to calculate a user selection rate for one or more combinations of dimension values that do not include the particular employer.

Offline modeler 464 may consider only event records that are “younger” than a few days or weeks. For example, offline modeler 464 may generate a model based on event records that were created in the last two weeks or event records that describe events (e.g., impression events or click events) that occurred in the last eighteen days.

Offline modeler 464 may create a model in one of many ways and embodiments are not limited to any particular type of model. Offline modeler 464 stores the model in ACFS store 462. For example, offline modeler 464 causes a set of pre-calculated user selection rates for different combinations of dimension values to be stored in ACFS store 462.

### Intelligent Pair Selection Event

Once a model is created, ACFS 430 sends, to ACFS store 462, for a particular content delivery campaign (which has been selected as part of a content item selection event), a request for one or more user selection rates. Thus, dimension values (i.e., of a set of attributes associated with a content request) are used to determine user selection rates of each content item-format pair considered in a pair selection event.

For the particular content delivery campaign, ACFS 430 may send multiple requests, one for each content item-format pair. Each request may specify the same set of dimension values (e.g., user data, social data, contextual data, and campaign identifier) except for a particular content item type and/or a particular format (e.g., “F3”). Alternatively, ACFS 430 sends a single request that indicates multiple content item-format pairs. Either way, for the particular content delivery campaign, ACFS 430 receives, from ACFS store 462, multiple user selection rates, each corresponding to a different content item-format pair. Thus, an indication of the content type and an indication of the format may be returned from ACFS store 462.

Because it is likely that the model does not have a user selection rate for a particular combination of dimension values, ACFS store 462 identifies a user selection rate that is associated with a subset of the dimension values received from ACFS 430. For example, requests from ACFS 430 have a maximum of four dimension values and a particular request includes dimension value set {D1A, D2B, D3C, D4C}. If ACFS store 462 does not store a user selection rate for this combination of dimension values, then ACFS store 462 identifies a user selection rate for a sub-combination of the dimension values, such as {D1A, D2B, D3C, *} or {D1A, *, *, D4D}, where * indicates that the corresponding value can be any value. ACFS store 462 may identify a sub-combination that matches the greatest number of dimension values. ACFS store 462 returns a user selection rate for each relevant content item-format pair.

The user selection rates of each content item-format pair are used to select a particular content item-format pair. Each user selection rate may be given equal weight. For example, if there are three content item-format pairs and the user selection rates are, respectively, 0.01, 0.04, and 0.05, then the first content item-format pair has a 10% chance of being selected, the second content item-format pair has a 40% chance of being selected, and the third content item-format pair has a 50% chance of being selected.

In an embodiment, a selection weight is determined for each content item-format pair. An example of a selection weight formula is as follows:

SelectionWeight(a,f)=CTR(a,f)̂alpha/Sum(CTR(i)̂alpha)

where a is a particular content item, f is a particular format, CTR(i) is a user selection rate for content item (limited to content items of a particular dynamic campaign), CTR(a, f) is a user selection rate for content item a with a format of f, alpha is a parameter that represents a greedy factor where possible values are greater than 0 and where a value of 1 indicates that a content item-format pair will be chosen proportional to its user selection rate relative to the total user selection rates of all possible content item-format pairs associated with the same dynamic campaign.

Thus, a content item-format pair is selected frequency wise, proportional to its selection weight. The higher a pair's selection weight, the greater the likelihood that that pair will be selected. However, even a content item-format pair with the lowest selection weight (in a pair selection event) has a chance to be selected.

The larger the value of alpha, the more exploitation. Conversely, the smaller the value of alpha, the more exploration. Balancing exploitation and exploration can be achieved by adjusting the value of alpha, which can be done dynamically. For example, as the number of pair selection events for a particular dynamic campaign increases, the value of alpha increases and approaches 1 or higher. Thus, the value of alpha may be adjusted based on a confidence level of the model. The confidence level may indicate how long ago the model was trained, the amount of training data upon which the model is based, an accuracy of the model, etc. An initial value of alpha may be determined manually or through one or more experiments.

### Variations

Instead of keeping track of performance data on a per content item-format pair basis, some embodiments keep track of performance on a per content item basis or a per content item type basis. For example, in one embodiment, there is only a single format for each content item type. Nevertheless, there may still be many content item types or even different content items of the same type that have different content, such as a different image, different text, and/or different graphics. For example, a dynamic campaign may be eight different content items of type “WorkWithUs” and two different content items of type “PictureYourself.” Each content item may be associated with different performance data. Embodiments described herein related to selecting a content item from among the eight options may be used.

Without embodiments herein, content providers would not be able to effectively test different content item-format pairs. Instead, a content provider would be required to create a content delivery campaign for each content item-format pair that the content provider would like to test and each pair would eventually compete with other campaigns from the same content provider. Even if a content provider created multiple individual campaigns, the content provider would have to manually track the progress of each campaign and manually adjust (e.g., lower the budget or decrease the bid price, or cancel) campaigns that are relatively low performing. Embodiments herein allow a content delivery exchange (or publisher) to remove such manual experimentation on behalf of the content provider by tracking progress of each content item-format pair and adjusting pair selection in real-time.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

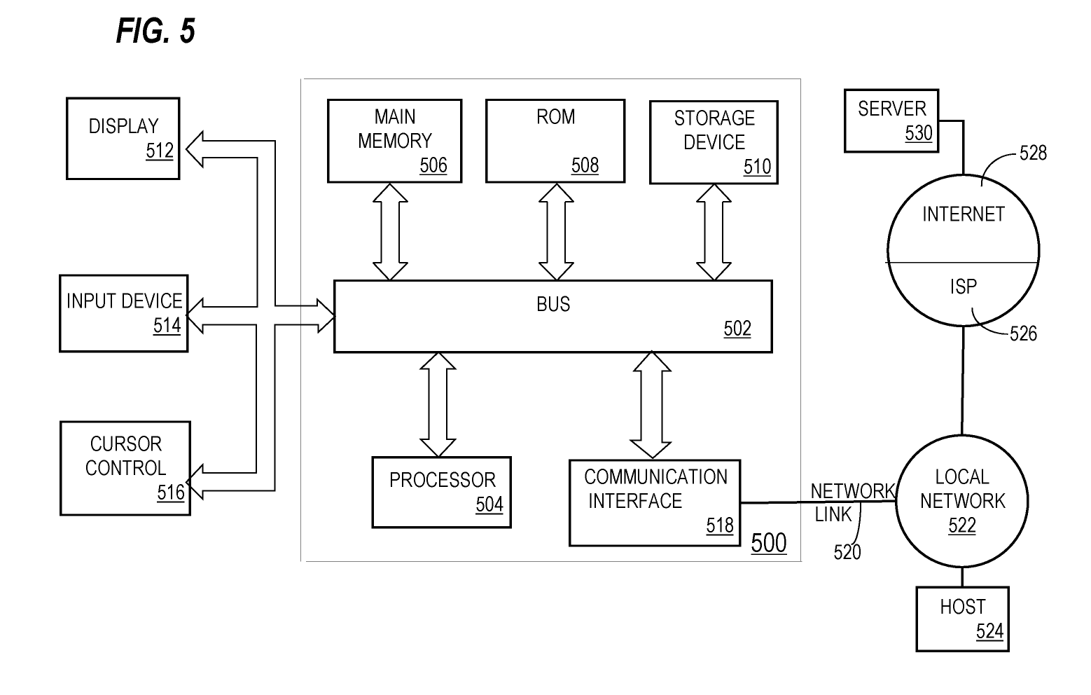

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
storing, for a particular content delivery campaign, a plurality of content items;
storing format data that identifies a plurality of formats;
in response to receiving a content request:
identifying a plurality of candidate content delivery campaigns that includes the particular content delivery campaign;
based on one or more selection criteria, selecting the particular content delivery campaign from among the plurality of candidate content delivery campaigns;
identifying a plurality of feature values associated with the content request;
identifying, based on the plurality of feature values, a plurality of entity selection rates, wherein each entity selection rate in the plurality of entity selection rates is associated with a different content item-format pair of a plurality of content item-format pairs given the plurality of content items of the particular content delivery campaign and the plurality of formats;
based on the plurality of entity selection rates, selecting a particular content item-format pair of the plurality of content item-format pairs, wherein the particular content item-format pair comprises a particular content item of the plurality of content items and a particular format of the plurality of formats;
causing the particular content item to be transmitted over a computer network and presented according to the particular format.

2. The system of claim 1, wherein the plurality of feature values include one or more contextual feature values of a contextual entity indicated in web content on which one of the plurality of content items will be displayed, one or more entity feature values of an entity that initiated the content request, and one or more campaign feature values.

3. The system of claim 2, wherein the one or more contextual feature values include one or more of a publisher identifier, a page identifier, a page zone identifier, a geographic location associated with the contextual entity, an organization associated with the contextual entity.

4. The system of claim 2, wherein one or more entity feature values include one or more of whether the entity has a profile picture, a job title associated with the entity, a geographic location associated with the entity, or an organization associated with the entity.

5. The system of claim 2, wherein the plurality of feature values include one or more social content features, wherein the one or more social content features include one or more matched jobs between the entity and the contextual entity, one or more matched connection referrals between connections of the entity and the contextual entity.

6. The system of claim 1, wherein the instructions, when executed by the one or more processors, further cause:
determining a plurality of weights, wherein each weight of the plurality of weights is based on a different entity selection rate of the plurality of entity selection rates and is for a different content item-format pair of the plurality of content item-format pairs;
wherein selecting the particular content item-format pair is also based on the plurality of weights.

7. The system of claim 6, wherein the entity selection rate of the particular content item-format pair is lower than an entity selection rate of another content item-format pair in the plurality of content item-format pairs.

8. The system of claim 6, wherein determining the plurality of weights is also based on a parameter that is assigned a first value, wherein the instructions, when executed by the one or more processors, further cause:
after causing the particular content item to be transmitted over the computer network, assigning a second value that is different than the first value to the parameter;
after assigning the second value to the parameter and in response to receiving a second content request:
identifying a second plurality of candidate content delivery campaigns that includes a second content delivery campaign;
based on one or more second selection criteria, selecting the second content delivery campaign from among the second plurality of candidate content delivery campaigns;
identifying a second plurality of feature values associated with the second content request;
identifying, based on the second plurality of feature values, a second plurality of entity selection rates, wherein each entity selection rate in the second plurality of entity selection rates is associated with a different content item-format pair of a second plurality of content item-format pairs;
based on the parameter, determining a second plurality of weights, wherein each weight of the second plurality of weights is based on a different entity selection rate of the second plurality of entity selection rates and is for a different content item-format pair of the second plurality of content item-format pairs;
based on the second plurality of entity selection rates and the second plurality of weights, selecting a second content item-format pair of the second plurality of content item-format pairs, wherein the second content item-format pair comprises a second content item and a second format;
causing the second content item to be transmitted over the computer network and presented according to the second format.

9. The system of claim 1, wherein:
a first strict subset of the plurality of content items can be formatted based on a first strict subset of the plurality of formats;
a second strict subset of the plurality of content items cannot be formatted based on the first strict subset of the plurality of formats.

10. The system of claim 1, wherein the instructions, when executed by the one or more processors, further cause:
storing event records, each indicating a different set of feature values;
identifying a first subset of the event records that have a first subset of feature values in common;
aggregating the first subset of the event records to generate a first value;
identifying a second subset of the event records that have a second subset of feature values in common;
wherein the second subset of feature values is different than the first subset of feature values;
aggregating the second subset of the event records to generate a second value.

11. The system of claim 10, wherein the first subset of event records and the second subset of event records includes a particular event record.

12. The system of claim 10, wherein the first subset of feature values correspond to a first set of features and the second subset of feature values correspond to a second set of features that is different than the first set of features.

13. A system comprising:
one or more processors;
one or more storage media storing instructions which, when executed by the one or more processors, cause:
storing, for a particular content delivery campaign, a plurality of content items;
storing format data that identifies a plurality of formats;
in response to receiving a content request:
identifying a plurality of candidate content delivery campaigns that includes the particular content delivery campaign;
based on one or more selection criteria, selecting the particular content delivery campaign from among the plurality of candidate content delivery campaigns;
identifying a plurality of feature values associated with the content request, wherein the plurality of feature values include one or more contextual feature values of a contextual entity indicated in web content on which one of the plurality of content items will be displayed, one or more entity feature values of an entity that initiated the content request, and one or more campaign feature values;
identifying, based on the plurality of feature values, a plurality of performance values, wherein each performance value in the plurality of performance values is associated with a different content item-format pair of a plurality of content item-format pairs given the plurality of content items of the particular content delivery campaign and the plurality of formats;
based on the plurality of performance values, selecting a particular content item-format pair of the plurality of content item-format pairs, wherein the particular content item-format pair comprises a particular content item of the plurality of content items and a particular format of the plurality of formats;
causing the particular content item to be transmitted over a computer network and presented according to the particular format.

14. The system of claim 13, wherein the plurality of performance values pertain to a particular objective, wherein the particular objective is one of an entity selection rate, a conversion rate, an audience reach, or engagement.

15. The system of claim 13, wherein:
the plurality of performance values pertain to a first objective and a second objective;
the first objective is an objective in set of objectives consisting of an entity selection rate, a conversion rate, an audience reach, and engagement;
the second objective is another objective in the set of objectives and is different than the first objective.

16. A method comprising:
storing, for a particular content delivery campaign, a plurality of content items;
storing format data that identifies a plurality of formats;
in response to receiving a content request:
identifying a plurality of candidate content delivery campaigns that includes the particular content delivery campaign;
based on one or more selection criteria, selecting the particular content delivery campaign from among the plurality of candidate content delivery campaigns;
identifying a plurality of feature values associated with the content request, wherein the plurality of feature values include one or more contextual feature values of a contextual entity indicated in web content on which one of the plurality of content items will be displayed, one or more entity feature values of an entity that initiated the content request, and one or more campaign feature values;
identifying, based on the plurality of feature values, a plurality of performance values, wherein each performance value in the plurality of performance values is associated with a different content item-format pair of a plurality of content item-format pairs given the plurality of content items of the particular content delivery campaign and the plurality of formats;
based on the plurality of performance values, selecting a particular content item-format pair of the plurality of content item-format pairs, wherein the particular content item-format pair comprises a particular content item of the plurality of content items and a particular format of the plurality of formats;
causing the particular content item to be transmitted over a computer network and presented according to the particular format;
wherein the method is performed by one or more computing devices.

17. The method of claim 16, wherein the plurality of performance values are a plurality of entity selection rates.

18. The method of claim 17, further comprising:
determining a plurality of weights, wherein each weight of the plurality of weights is based on a different entity selection rate of the plurality of entity selection rates and is for a different content item-format pair of the plurality of content item-format pairs;
wherein selecting the particular content item-format pair is also based on the plurality of weights.

19. The system of claim 16, wherein the one or more contextual feature values include one or more of a publisher identifier, a page identifier, a page zone identifier, a geographic location associated with the contextual entity, an organization associated with the contextual entity.

20. The system of claim 16, wherein the plurality of feature values include one or more social content features, wherein the one or more social content features include one or more matched jobs between the entity and the contextual entity, one or more matched connection referrals between connections of the entity and the contextual entity.
